(19) United States
(12) Patent Application Publication
(10) Pub. No.: US 2003/0145676 A1
(43) Pub. Date: Aug. 7, 2003

(54) Starter flywheel with a ring gear being fixed via its radial surface

(76) Inventors: Jean Bonnefous, Reze (FR); Frank Douillard, La Bernardiere (FR); Serge Gaudu, Montaigu (FR)

Correspondence Address: BACHMAN & LAPOINTE, P.C., 900 CHAPEL STREET, SUITE 1201, NEW HAVEN, CT, 06510, US

(21) Appl. No.: 10/307,853

(22) Filed: Dec. 2, 2002

(30) Foreign Application Priority Data
Dec. 4, 2001 (FR) 0115653

(51) Int. Cl. G05G 1/00

(52) U.S. Cl. 74/572

(57) ABSTRACT

A flywheel for an internal combustion engine comprises a support and a ring gear. The support possesses a radial surface and the ring gear possesses a complementary radial surface. According to the invention, the ring gear is shaped in such a manner as to allow the ring gear to deform radially towards the axis of rotation of the flywheel at least in certain deformation angular sectors corresponding to compression and expansion zones of the pistons of the engine, and the complementary radial surface is fixed to the radial surface in fixing annular sectors that are situated between adjacent pairs of deformation angular sectors.

The present invention relates to a starter flywheel suitable for meshing with a starter pinion to start an internal combustion engine, in particular for vehicles such as automobiles.

### BACKGROUND OF THE INVENTION

Starter flywheels for internal combustion engines are known that are rotatable about an axis of rotation, such a flywheel comprising a support and a ring gear fixed to the support, in which the support possesses an outer peripheral end presenting a radial surface and a peripheral surface and the ring gear possesses an inner peripheral end possessing a complementary radial surface and a complementary peripheral surface.

An important problem relating to starter flywheels concerns lifetime. Such flywheels are generally capable of withstanding and performing somewhere between 20,000 to 60,000 starts, but that is becoming insufficient given draft legislation seeking to require engines to be turned off whenever the vehicle is stationary (at a red light, in a traffic jam, . . . ).

In French patent application No. 99/12240 of Sep. 30, 1999, the Applicant describes a flywheel in which the ring gear is fixed to the support via their respective peripheral surface and complementary peripheral surface, and in which the fixing enables the ring gear to deform radially. Such flywheels can easily withstand 200,000 to 300,000 starts.

A drawback with those “long lifetime” flywheels is the difficulty in controlling the outer beating of the ring gear relative to the crankshaft.

The flywheel and the ring gear are machined separately, and in particular they have mechanical tolerances that apply to machining the inside diameter of the complementary peripheral surface of the ring gear and the outside diameter of the peripheral surface of the support. During assembly of the flywheel, fixing the complementary peripheral surface of the ring gear to the peripheral surface of the support means that the radial tolerances of the two parts are cumulative once the flywheel has been assembled.

### OBJECT AND SUMMARY OF THE INVENTION

The problem posed is to have a flywheel in which the outer beating of the ring gear relative to the crankshaft needs to be reduced while maintaining a structure that makes it possible for lifetime to lie in the range at least 200,000 to 300,000 starts.

The invention provides a flywheel for an internal combustion engine, the flywheel being mounted to rotate about an axis of rotation and comprising a support and a ring gear fixed to the support, the support possessing an outer peripheral end having a radial surface, and the ring gear possessing an internal peripheral end having a complementary radial surface, wherein the ring gear is shaped in such a manner as to enable the ring gear to deform radially towards the axis of rotation of the flywheel, at least within certain deformation angular sectors corresponding to the compression and expansion zones of the pistons of the engine, and wherein the complementary radial surface is fixed to the radial surface in fixing angular sectors situated between pairs of adjacent deformation angular sectors.

In the invention, the mechanical tolerances on machining the inner diameter of the complementary peripheral surface and the outer diameter of the peripheral surface are no longer cumulative once the flywheel has been assembled since those two surfaces no longer act as surfaces for positioning the ring gear relative to the support during assembly of the flywheel, nor are they used for fixing the ring gear to the support.

### BRIEF DESCRIPTION OF THE DRAWINGS

Other features of the present invention appear from the following description of embodiments given by way of non-limiting example. In the drawings:

FIG. 1 is a face view of a flywheel constituting a first embodiment of the invention;

FIG. 2 is a radial section view on line I-I of FIG. 1;

FIG. 3 is a radial section view on line II-II of FIG. 1;

FIG. 4 is a detail view of the radial end IV of FIG. 2;

FIG. 5 is a detail view of the radial end V of FIG. 3;

FIG. 6 is a view similar to FIG. 4 showing a second embodiment of the invention; and

FIG. 7 is a view similar to FIG. 5 showing the second embodiment of the invention.

### MORE DETAILED DESCRIPTION

A flywheel 1 for an internal combustion engine is mounted to rotate about an axis of rotation 2. The flywheel 1 comprises a support 3 which is mechanically connected to the crankshaft, e.g. by bolting, and a ring gear 4 which is connected to the support 3.

The support 3 and the ring gear 4 present respectively an outer peripheral end 5 and a complementary inner peripheral end 6, the inner peripheral end 6 of the ring gear 4 being fixed to the outer peripheral end 5 of the support 3. The outer peripheral end 5 has a peripheral surface 7 and a radial surface 8. Similarly, the inner peripheral end 6 presents a complementary peripheral surface 9 and a complementary radial surface 10.

The ring gear 4 is fixed to the support 3 by fixing the complementary radial surface 10 of the ring gear 4 to the radial surface 8 of the support 3 in such a manner as to allow the ring gear 4 to deform radially towards the axis of rotation 2 during meshing of the ring gear 4 with the pinion of the starter.

In order to allow the ring gear 4 to deform radially, clearance 13 is left between the peripheral surface 7 of the support 3 and the facing complementary peripheral surface 9 of the ring gear 4. There is therefore no contact between the peripheral surface 7 of the support and the complementary peripheral surface 9 of the ring gear 4.

The ring gear 4 is shaped in such a manner as to allow the ring gear 4 to deform radially towards the axis of rotation 2 of the flywheel 1 at least in deformation angular sectors 12 corresponding to compression zones and expansion zones of the pistons of the engine, and is fixed via its complementary radial surface 10 to the radial surface 8 in fixing angular sectors 14, each of which is situated between two adjacent deformation angular sectors 12.

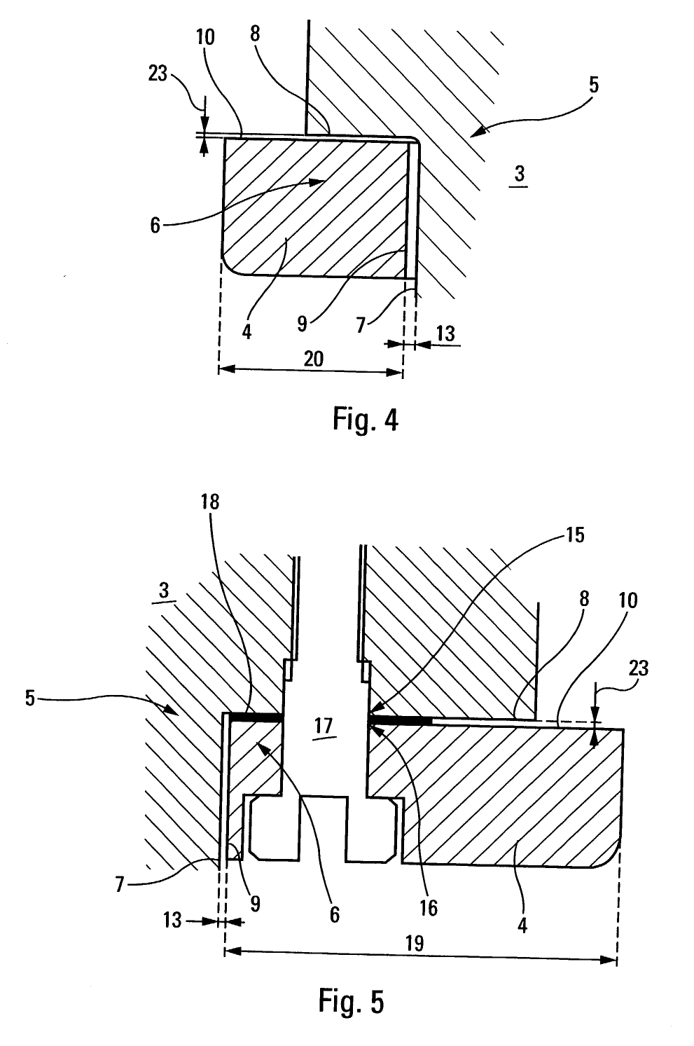

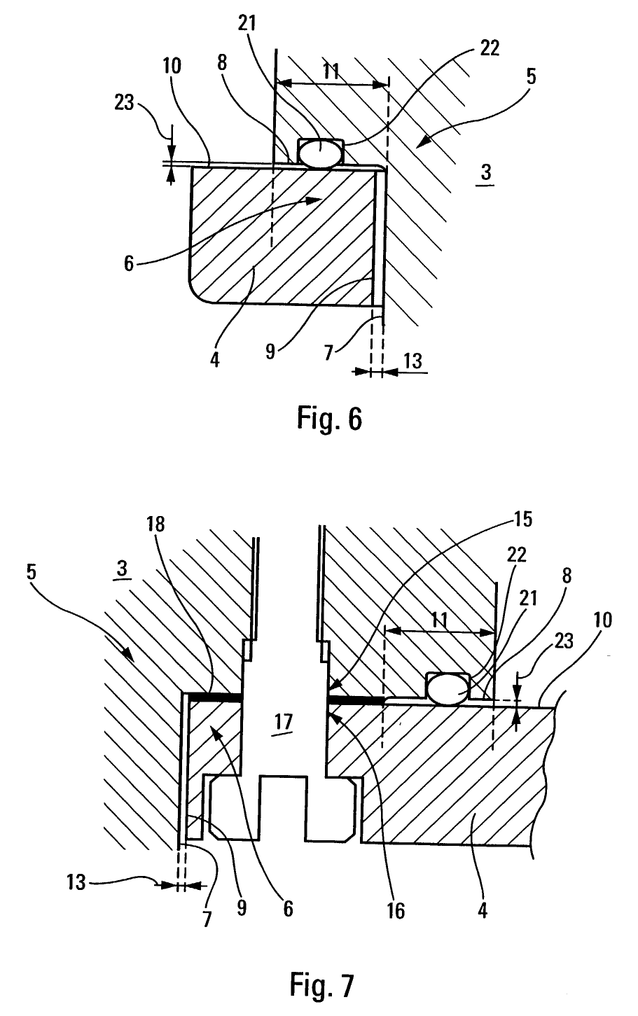

In order to facilitate radial deformation of the ring gear 4, there is clearance 23 between the radial surface 8 of the support 3 and the complementary radial surface 10 of the ring gear 4 that faces it over the extent of at least all of the deformation angular sectors 12. FIGS. 4 and 6 are section views on a radius situated in a deformation angular sector 12, and it can be seen that there is no contact between the entire radial surface 8 of the support 3 and the entire complementary radial surface 10 of the facing ring gear 4.

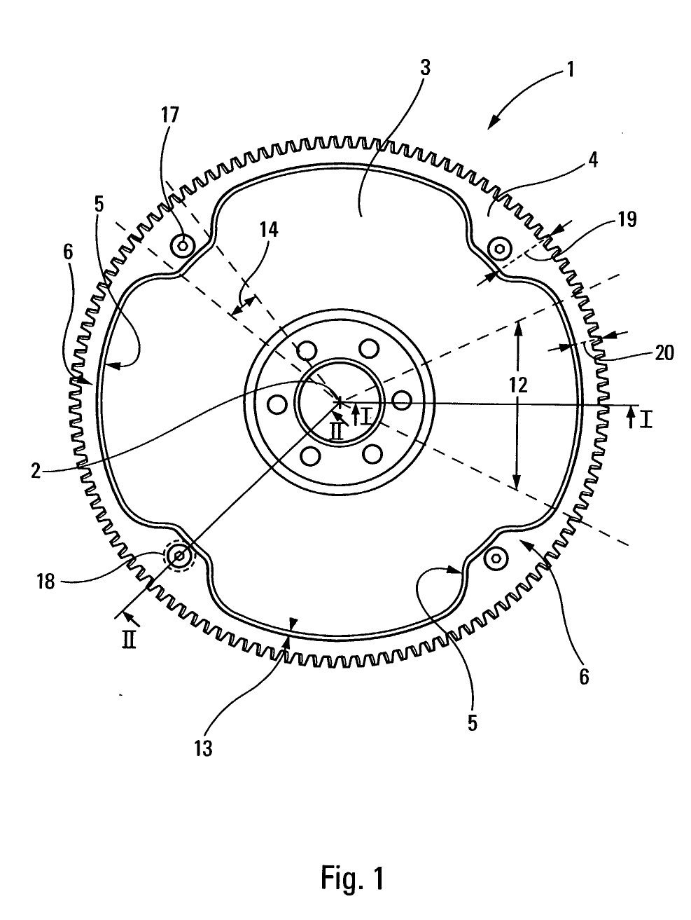

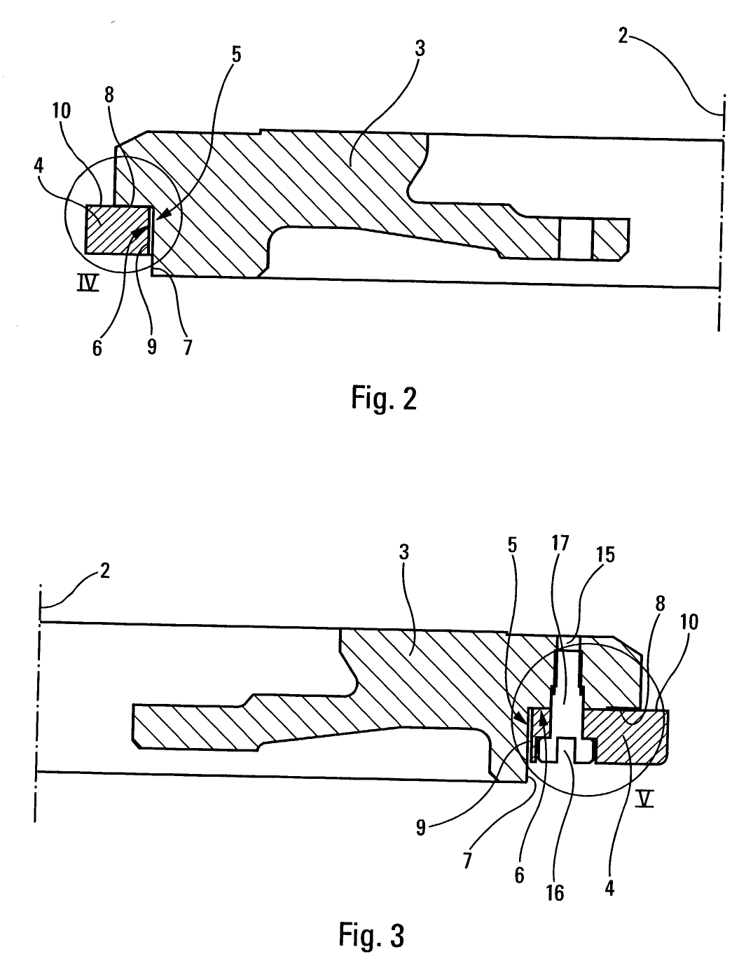

In the embodiments shown in FIGS. 1 to 7, the radial surface 8 of the support 3 has orifices 15 in the fixing angular sectors 14, and the complementary radial surface 10 of the ring gear 4 has complementary orifices 16 in the same fixing angular sectors 14.

The orifices 15 and the complementary orifices 16 extend parallel to the axis of rotation 2 of the flywheel 1. Each orifice 15 opens out into the radial surface 8, and each complementary orifice 16 opens out into the complementary radial surface 10, and faces the corresponding orifice 15.

The ring gear 4 is fixed to the support 3 by screws 17 each of which is screwed into an orifice 15 and the corresponding complementary orifice 16.

Clamping contact between the radial surface 8 of the support 3 and the complementary radial surface 10 of the ring gear 4 is restricted to the clamping contact zones 18 adjacent to the orifices 15 and to the complementary orifices 16.

In the embodiments shown in FIGS. 1 to 7, there is also clearance 23 between the radial surface 8 of the support 3 and the complementary radial surface 10 of the ring gear 4 facing it outside the deformation angular sectors 12: as can be seen in FIGS. 5 and 7 which are section views on a radius situated in a fixing angular sector 14, there is no contact between the radial surface 8 and the complementary radial surface 10 outside the clamping contact zone 18.

The ring gear 4 has radial thickness 19, 20 that depends on angular offset from one of the deformation angular sectors 12. The radial thickness 20 of the ring gear 4 in the deformation angular sectors 12 is less than the radial thickness 19 of the ring gear 4 in the fixing angular sectors 14.

In the example shown in FIGS. 1 to 7, the radial thickness 19 of the ring gear 4 for the angular sectors comprising the clamping contact zones 18 is greater than the radial thickness 20 of the ring gear 4 for the angular sectors that are remote from the clamping contact zones 18.

The small thickness 20 in the deformation angular sectors facilitates radial deformation of the ring gear, and the larger thickness 19 in the fixing angular sectors 14 provides a contact area that is large enough to provide reliable fixing of the ring gear 4 on the support 3.

In the embodiment shown in FIGS. 6 and 7, the flywheel 1 has an annular gasket 21 of viscoelastic material which is put under stress in the axial and radial directions in an annular groove 22 formed in the radial surface 8 of the support 3 and which also comes into contact with the complementary radial surface 10 of the ring gear 4.

As can be seen in FIGS. 6 and 7, the angular groove 22 is made in a radial ring 11 of the radial surface 8 of the support 3, the clearance 23 between the radial surface 8 and the complementary radial surface 10 existing along the surface of the radial ring 11. In spite of the distance between the radial surface 8 and the complementary radial surface 10 over the extent of the radial ring 11, the annular gasket 21 is in contact with the complementary radial surface 10 and is under compression stress in the axial and radial directions.

The angular gasket 21 enables starter noise to be reduced by absorbing the vibrations that transmit the sound wave through a solid path.

It is clearly possible to make the annular groove 22 in the complementary radial surface 10 of the ring gear 4, with the annular gasket 21 then coming into contact with the radial surface 8 of the support 3.

A flywheel 1 has thus been described in which the ring gear 4 is fixed to the radial surface 8 of the support 3 via its complementary radial surface 10 so as to allow the ring gear 4 to deform radially during meshing of the ring gear 4 with the starter pinion.

In addition, such an invention makes it possible to assemble the flywheel 1 without taking account of the mechanical tolerances on machining the peripheral surface 7 and the complementary peripheral surface 9.

A flywheel 1 may be manufactured, for example, by performing the following steps:

positioning the complementary radial surface 10 on the radial surface 8, the ring gear 4 and the support 3 having their axes of rotation coinciding with the axis of rotation of the flywheel 1;

piercing each orifice 15 opening out into the radial surface 8 in an axial direction in continuation with the complementary orifice 16, thus enabling the ring gear 4 to be positioned angularly and radially relative to the support, without the dimensional differences of the peripheral surface 7 and the complementary peripheral surface 9 being involved; and

inserting a screw 17 into each orifice 15 and the corresponding complementary orifice 16 so as to assemble together the complementary radial surface 10 of the ring gear 4 and the radial surface 8 of the support 3, the orifices 15 and the complementary orifices 16 naturally being in alignment since they are pierced continuously one after the other.

By fixing the ring gear 4 to the support 3 via the radial surface 8 and the complementary radial surface 10, beating of the ring gear 4 relative to the axis 2 is thus reduced by a factor lying in the range 2 to 3 compared with ring gears that are fixed together via a peripheral surface and a complementary peripheral surface.

In addition, the lifetime of the flywheel is increased (this is in addition to the radial deformation of the ring gear) by increasing the driving ratio: reducing mechanical tolerances makes it possible to increase the outside diameter of the ring gear.

Naturally, the flywheel of the present invention needs to be provided with means for indexing its position on the axis of rotation 2 that are precise and reliable so as to ensure that the deformation angular sectors 12 provided in the ring 4 correspond accurately to the compression and expansion zones of the various cylinders of the engine.

The flywheel 1 shown in FIG. 1 has four deformation angular sectors 12 and is therefore adapted for fitting to a four-cylinder engine.

More generally, there are as many deformation angular sectors 12 as there are pistons connected to the crankshaft driving the flywheel 1.

Naturally, the present invention is not limited to the above-described embodiments, and numerous changes and modifications can be applied thereto without going beyond the ambit of the invention.

What is claimed is:

1/ A flywheel for an internal combustion engine, the flywheel being mounted to rotate about an axis of rotation and comprising a support and a ring gear fixed to the support, the support possessing an outer peripheral end having a radial surface, and the ring gear possessing an internal peripheral end having a complementary radial surface, wherein the ring gear is shaped in such a manner as to enable the ring gear to deform radially towards the axis of rotation of the flywheel, at least within certain deformation angular sectors corresponding to the compression and expansion zones of the pistons of the engine, and wherein the complementary radial surface is fixed to the radial surface in fixing angular sectors situated between pairs of adjacent deformation angular sectors.

2/ A flywheel according to claim 1, wherein the outer peripheral end of the support has a peripheral surface, wherein the inner peripheral end of the ring gear has a complementary peripheral surface, and wherein there is clearance between the peripheral surface of the support and the facing complementary peripheral surface of the ring gear.

3/ A flywheel according to claim 1, wherein the radial surface has a plurality of orifices extending parallel to the axis of rotation of the flywheel in the fixing angular sectors, wherein the complementary radial surface has a plurality of complementary orifices extending parallel to the axis of rotation of the flywheel in the fixing angular sectors, and wherein the ring gear is fixed to the support by means of screws co-operating with the orifices and the complementary orifices.

4/ A flywheel according to claim 3, wherein there is clamping contact between the radial surface of the support and the complementary radial surface of the ring gear that faces it, at least in the contact zones adjacent to the orifices and to the complementary orifices.

5/ A flywheel according to claim 1, wherein the radial thickness of the ring gear in the deformation angular sectors is less than the radial thickness of the ring gear in the fixing angular sectors.

6/ A flywheel according to claim 1, including an annular gasket of viscoelastic material put under stress in the axial and radial directions in an annular groove formed in one of the surfaces constituted by the radial surface and the complementary radial surface, and which comes into contact with the other one of said surfaces.

7/ A flywheel according to claim 6, wherein there is clearance between the radial surface and the complementary radial surface facing it over the extent of a radial ring, the annular groove being formed in the extent of the radial ring.

8/ A method of manufacturing a flywheel by assembling together a ring gear possessing an inner peripheral end having a complementary radial surface to a support possessing an outer peripheral end having a radial surface, wherein the following steps are performed:
positioning the complementary radial surface coaxially on the radial surface;
continuously piercing orifices opening out into the radial surface and complementary orifices opening out into the complementary radial surface and extending said orifices along the direction of the axis of rotation of the flywheel; and
inserting a screw into each orifice and into the corresponding complementary orifice so as to assemble together the complementary radial surface and the radial surface.
